(19) United States
(12) Patent Application Publication
(10) Pub. No.: US 2024/0183093 A1
(43) Pub. Date: Jun. 6, 2024

(54) STITCH BONDED CLEANING PAD WITH VARIABLE HEIGHT LOOP ELEMENTS

(71) Applicant: Tietex International Ltd., Spartanburg, SC (US)

(72) Inventor: MARTIN WILDEMAN, SPARTANBURG, SC (US)

(21) Appl. No.: 18/553,440

(22) PCT Filed: Apr. 19, 2022
(86) PCT No.: PCT/US2022/025352

§ 371 Date: Sep. 29, 2023

Related U.S. Application Data
(60) Provisional application No. 63/177,093, filed on Apr. 20, 2021.

(51) Int. Cl. D05C 17/02; A47L 13/20; B32B 5/02; B32B 5/10; D04H 1/435; D04H 1/52

(52) U.S. Cl. CPC D05C 17/026; A47L 13/20; B32B 5/022; B32B 5/10; D04H 1/435; D04H 1/52; D05C 17/023; B32B 2262/0276; B32B 2307/726; B32B 2307/7375; B32B 2432/00; D10B 2403/0111; D10B 2503/00

(57) ABSTRACT

A disposable cleaning pad of stitch-bonded construction adapted to be affixed to a mop head for manipulation across a surface to be cleaned. The cleaning pad includes a sorbent stitching substrate of fleece in layered relation with at least one support layer. A first yarn feed and a second yarn feed are in stitched relation through a stitched portion of the stitching substrate. The first yam feed forms a first loop collection, and the second yarn feed forms a second loop collection. The second loop collection covers a smaller area than the first loop collection and defines a predefined pattern within the stitched portion of the stitching substrate. The second loop collection has an average pile height greater than the first loop collection.

### CROSS-REFERENCE TO RELATED APPLICATION(S)

This nonprovisional application claims the benefit of, and priority from commonly owned provisional application 63/177,093 having a filing date of 20 Apr. 2021. The contents of such prior application and any other documents referenced in this application are hereby incorporated by reference in their entirety as if fully set forth herein.

### TECHNICAL FIELD

The present disclosure relates generally to cleaning systems for floors and other surfaces. More particularly, this disclosure relates to cleaning systems using disposable sorbent pads with a construction incorporating a cleaning surface overlying a fluid retaining interior and adapted for attachment to a user manipulated mop head for scrubbing and sorption of applied cleaning fluid. Exemplary non-limiting uses may include domestic or industrial cleaning of hard surfaces, floors, bathrooms, kitchens, and the like.

### BACKGROUND

Fabric formation using so-called stitch bonding techniques is well known. In such processes, a multiplicity of stitching yarns is passed repeatedly in stitching relation through one or more substrate layers in closely spaced rows to form a coordinated arrangement of surface stitches in covering relation to the substrate. It is possible to use such stitch bonding techniques to form substantially uniform surfaces covered by the stitching yarns. It is also possible to impart patterns of stitching yarns across the surface by manipulation of the formation process. Such patterns may use upstanding loops, substantially flat stitches, or combinations thereof.

It is also known to use disposable cleaning pads which are adapted to be affixed to a mop head for manipulation across a surface to be cleaned. Such pads may incorporate an arrangement of layers that are held together in stacked relation. As best understood, the layers in such prior cleaning pads perform various specific functions wherein the bottom layer adapted to face away from a user manipulated handle provides a scrubbing surface and interior layers of fibrous material serve to absorb and hold fluid from the surface being cleaned.

### SUMMARY

The present disclosure provides advantages and/or alternatives over the prior art by providing a pad structure of stitch bonded construction incorporating one or more substrate layers of a fluid retaining fibrous material in combination with one or more layers of supporting substrate material and optionally including and additional fluid blocking substrate layer of polymer film or other suitable material. By way of example only, and not limitation the present disclosure may be adapted to improve pad structures as disclosed U.S. Pat. Nos. 8,863,347; 9,049,974; 9,693,668; 10,010,23; and U.S. Pat. No. 10,925,457 to Wildeman. The contents of all such patents are hereby incorporated by reference in their entirety as if fully set forth herein.

As in the referenced patents, stitching yarns of multi-filament construction are introduced in stitching relation through the substrate layers. One face of the pad defines a cleaning surface of raised yarn loops formed by the stitched yarns. The pad further includes an attachment surface facing away from the cleaning surface. The stitches of yarns across the attachment surface define an engagement surface for attachment to cooperating hooking elements across a surface of a mop head to define a hook and loop attachment system.

Pad structures formed in accordance with the present disclosure provide an improved 3-dimensional, patterned pile surface formed wholly or partially by pile loops of varying pile heights. Surprisingly, the varying heights may be achieved using pile-forming elements of either uniform height or varying height as may be desired. By way of example only, in one exemplary construction variable pile height within the same piece of material ranging from about 2 mm in the low pile areas up to about 6 mm or greater in the high pile areas may be achieved.

Floor pads consistent with the present disclosure may be particularly beneficial for cleaning surfaces that are not completely flat. By way of example only, such surfaces may include highly textured floor surfaces and/or tiled floors with grouted joints that might be at a lower elevation than the tile surfaces. Furthermore, the higher pile areas may have greater pile yarn density which provides enhanced stiffness and scrubbing features for cleaning.

### BRIEF DESCRIPTION OF THE DRAWINGS

The accompanying drawings which are incorporated in, and which constitute a part of this specification, illustrate exemplary constructions and procedures in accordance with the present disclosure and, together with the general description of the disclosure given above, and the detailed description set forth below, explain the principles of the disclosure wherein:

FIG. 1 illustrates schematically a two-bar stich bonding machine setup using multiple yarns and/or heavier yarns in one bar and single yarns and/or lighter yarns in the other bar to form an exemplary cleaning pad material with one or more layers of fluid collecting fibrous substrate material and with projecting pile loops of varying height consistent with the present disclosure;

FIG. 2 illustrates an exemplary two-bar stitch bonding pattern adapted to form an exemplary cleaning pad material using one or more layers of substrate material with projecting pile loops of varying height consistent with the present disclosure;

FIG. 3 is a schematic view illustrating a potentially preferred cleaning pad formed by the stitching pattern of FIG. 1 having one or more layers of fluid collecting fibrous substrate material and projecting pile loops of varying height consistent with the present disclosure; and

FIG. 4 is a schematic perspective view of a potentially preferred floor pad material with pile loops of varying height consistent with the present disclosure.

While the disclosure has been illustrated and will hereinafter be described in connection with certain exemplary embodiments and practices, it is to be understood that in no event is the disclosure to be limited to such illustrated and described embodiments and practices. On the contrary, it is intended that the present disclosure shall extend to all alternatives and modifications as may embrace the general principles of this disclosure within the full and true spirit and scope thereof.

### DESCRIPTION OF THE PREFERRED EMBODIMENTS

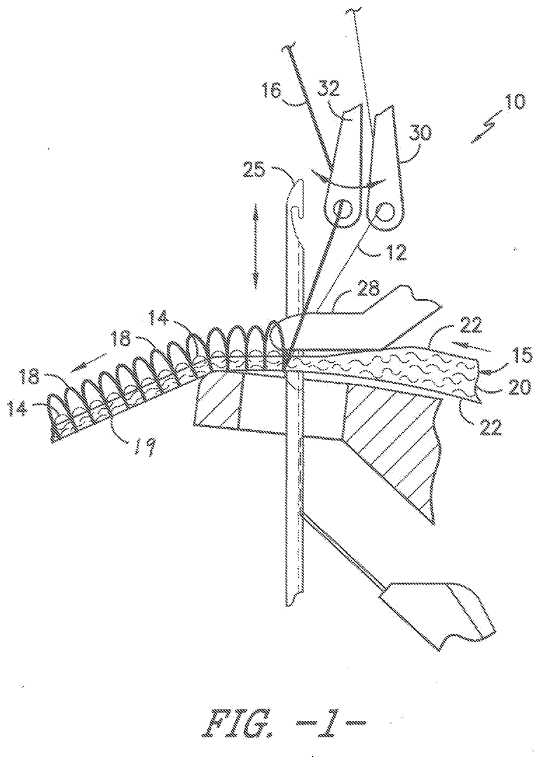

Reference will now be made to the drawings, wherein like elements are designated by like reference numerals in the various views. FIG. 1 illustrates an exemplary multi-bar stich-bonding machine 10 useful in forming a variable loop height material consistent with the present disclosure. In this regard, it will be understood that stich-bonding machine 10 preferably uses at least 2 guide bars with independent yarn beam let-off mechanisms for each respective guide bar delivering separate yarn feeds to the stitching location. As illustrated, in accordance with one potentially preferred practice, a first guide bar (preferably the back bar) delivers a first yarn feed 12 for formation of a first loop collection 14 of relatively low profile loops at least partially across a sorbent stitching substrate 15. A second guide bar (preferably the front bar) may deliver a second yarn feed 16 for formation of a second loop collection 18 across select portions of the stitched surface. As illustrated, the second loop collection 18 is preferably characterized by a pile height which is greater than the first loop collection 14. In this regard, the first guide bar delivering the first yarn feed 12 may be either fully or partially threaded to create either a full or partial pile surface respectively, while the second guide bar is partially threaded to create a patterned effect on the fabric surface. The first yarn feed 12 and the second yarn feed 16 also preferably form a plurality of substantially flat stitches across the underside 19 of stitching substrate 15. The stitches of yarns across the underside 19 define an engagement surface for attachment to cooperating hooking elements across a surface of a mop head or other manipulating structure to define a hook and loop attachment system.

It is to be understood that the stitching substrate 15 may have any suitable construction to provide fluid collection of applied cleaning fluids. Suitable constructions may include those disclosed in any of U.S. Pat. Nos. 8,863,347; 9,049,974; 9,693,668; 10,010,23; and U.S. Pat. No. 10,925,457 to Wildeman (incorporated by reference). By way of example only, and not limitation, the stitching substrate 15 is preferably formed from one or more layers of a fiber fleece 20 of polyester, cotton, rayon or the like having a mass per unit area of 100 to 400 grams per square meter (preferably about 150 gsm). As shown, the fleece 20 may be fed into the stitch bonding machine 10 together with at least one pre-formed supporting cover material 22 such as a polypropylene spun bond fabric or the like. More preferably, the fleece 20 may be fed in unattached sandwiched relation between two layers of pre-formed supporting cover material 22. Of course, it is to be understood that materials other than polypropylene spun bond fabric may likewise be used for the supporting cover layers including polyethylene, nylon and other fibrous materials with spun bond, melt blown, woven, knit or other constructions as well as non-fiber polymer films and the like suitable to provide dimensional stability. The supporting cover layers 22 on the top and bottom may be formed from the same material or from different materials as desired. No absorbency-enhancing polymers are typically required in the stitching substrate 15, although such additives may be included in the fleece if desired.

As will be understood, the stitch bonding machine 10 includes a multiplicity of needles 25 (only one shown) across the machine. In accordance with one exemplary practice, the first yarn feed 12 and the second yarn feed 16 may be stitched at the same reciprocating needles 25 using raised pile sinkers 28 between needles such that both yarn feeds produce loops across the so called “technical back” of the stitched fabric construction and with knotted stitches across the so called “technical face”. Specifically, pile sinkers 28 hold portions of yarn feeds 12, 16 above the stitching substrate 15 as needles 25 move downward such that those elevated portions retain a loop configuration above the stitching substrate 15 as they move off the sinkers 28. However, due to differences in the yarn feed materials, yarn feed 16 may produce significantly higher loops than yarn feed 12 as will be described further hereinafter.

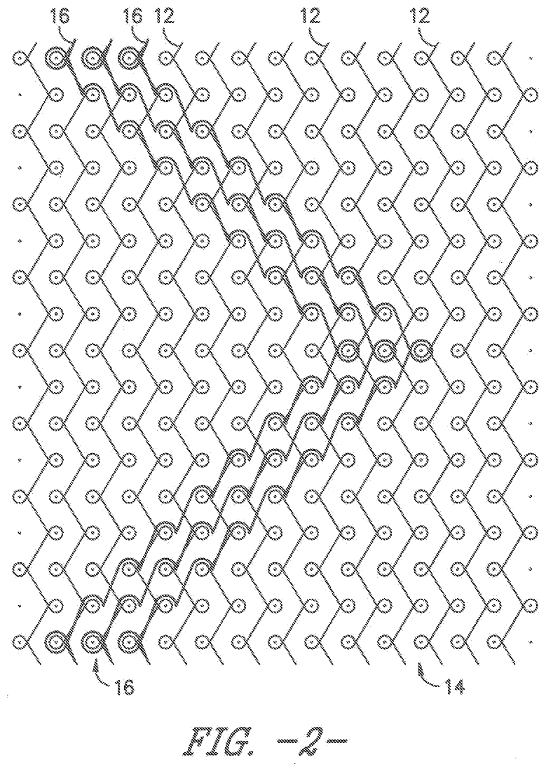

As best seen through joint reference to FIG. 1 and the needle point diagram of FIG. 2, the back bar carrying first yarn feed 12 may be fully threaded across the stitching zone with yarn feed 12 being manipulated by moveable yarn guides 30 and stitching being carried out using a zigzag atlas stitch with a repeating stitch notation of 1,0/1,2// or the like. As will be understood, such a construction produces a relatively disperse first loop collection 14 across the technical back with loops being formed between the needle perforation points. The zigzag stitch pattern leaves significant zones of the underlying substrate uncovered by the stitching yarns thereby avoiding substantial substrate compression. In this regard, it is contemplated that first yarn feed 12 will be stitched to produce a cover factor of not greater than 85% across the underlying stitching substrate such that in the stitched zones, at least 15% or more of the underlying stitching substrate surface area remains uncovered by the yarns making up first yarn feed 12. More preferably, first yarn feed 12 will be stitched to produce a cover factor in the range of 45% to 80% in the stitched zones such that 20% to 55% of the underlying stitching substrate surface area remains uncovered by the yarns making up first yarn feed 12. In some constructions, even lower cover factors of 30% or lower in the stitched zones may be used if desired. Of course, some zones may remain unstitched. As will be appreciated, the described cover factors may be contrasted with those produced by a chain stich or other pattern forming a substantially continuous ground covering. In this regard, a filly threaded chain stitch will typically provide cover factors of 90% or greater.

As best seen through reference to FIG. 2, the front bar carrying second yarn feed 16 may be only partially threaded such that a percentage of the needles 25 are not engaged. That is, only some of the needles engaging first yarn feed 12 will also engage second yarn feed 16. By way of example only, in the illustrated exemplary threading pattern of FIG. 2, second yarn feed 16 may be threaded in a repeating pattern to engage three consecutive needles in the stitching line and then skip 24 needles before engaging another three consecutive needles. Accordingly, the illustrated threading is “in 3, miss 24”. Of course, the threading for second yarn feed 16 may use any number of threaded and missed needles as may be desired.

As further seen in FIG. 2, the partially threaded second yarn feed 16 may be manipulated by moveable yarn guides 32 to impart predefined patterning to the second loop collection 18 across the stitching substrate 15. By way of example only, in the illustrated, exemplary construction, stitching pattern may have a repeating notation of: 1,0/1,2/2,3/3,4/4,5/5,6/6,7/7,8/8,9/8,7/7,6/6,5/5,4/4,3/3,2/2,1//.

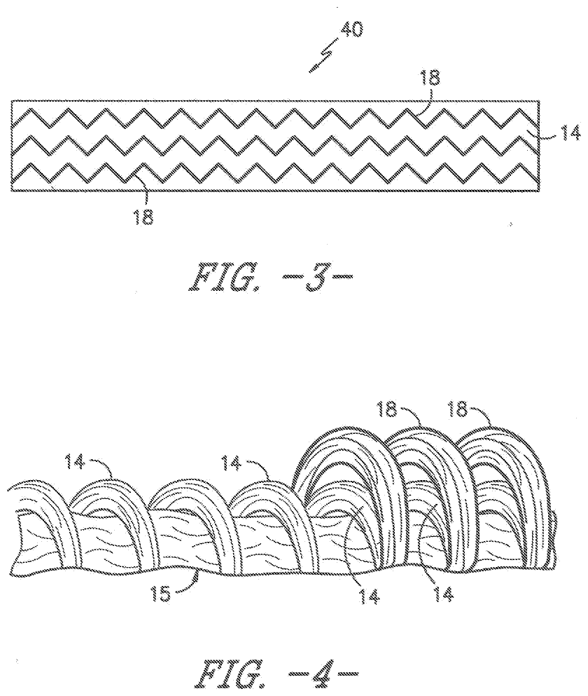

As illustrated the noted stitching setup will produce a second loop collection pattern with a relatively wide linear sine wave structure extending in the machine direction of the fabric produced. FIG. 3 illustrates a resulting cleaning pad 40 incorporating such patterning of the second loop collection 18. Of course, such a stitching notation is exemplary only and any other pattern notation may likewise be used. By way of example, a notation of: 1,0/1,2/2,3/3,4/4,5/5,6/5,4/4,3/3,2/2,1// may be used to produce a narrower pattern. Of course, other non-sinusoidal patterns for the second loop collection 18 may likewise be used as desired.

In accordance with one exemplary aspect of the present disclosure, it has been found that even when using pile sinkers 28 or other loop-forming elements of identical height, a substantial pile height difference may be produced between the two guide bars by using a second yarn feed 16 having a significantly higher total denier of yarn relative to the first yarn feed 12. By way of example only, and not limitation, in one exemplary practice, the second yarn feed 16 may use 2.5 to 6 times (preferably 3.5 to 5 times) as much yarn denier in the guide needle of the second guide bar relative to the first yarn feed 12 in the first guide bar. This can be achieved either by using a heavier denier yarn in the second guide bar than that used in the first guide bar and/or by combining multiple yarns together within individual guide needles.

In accordance with one non-limiting exemplary construction, the fabric may be made with about 10 to about 18 needles per inch (i.e. gauge) in the cross-machine direction (preferably about 14 gauge) with a preferred cpi of about 12 to 24 stitches per inch (preferably about 18 stitches/inch) in the machine direction using 4 mm high pile forming sinkers 28. The back bar may provide a fully threaded first yarn feed 12 of 150 denier, 288 filament textured polyester (DTY) at one end per needle stitched at a notation of 1,0/1,2// or equivalent. As noted previously, such a zigzag stich pattern mitigates against the substantial substrate compression that would occur with a ground covering formed by a full chain stitch or the like. The front bar provides a partially threaded second yarn feed 16 of 150 denier, 34 filament textured polyester (DTY) at four ends per needle. Thus, in the potentially preferred exemplary construction, the second yarn feed 16 may deliver yarn density levels approximately four times greater than the first yarn feed 12 in the stitched zones. According to one potentially preferred practice, loops forming the second loop collection 18 may an average yarn density in the range of 2 to 5 times the average yarn density of loops forming the first loop collection 14.

Without being limited to a specific theory, it is theorized that having greater yarn density in specific needles may create a tighter fabric structure at that needle thereby leading to an unexpected increase in demand for the yarn feed length and increased pile loop height in the areas stitched with this higher density of yarn. It is also theorized that stiches formed with higher cumulative denier yarn elements will require a greater radius thereby enhancing their projection. This contrasts with finer yarn elements that form stiches that are longer and flatter. This distinction between the high radius stitches and longer, flatter stiches is best seen in FIG. 4.

Additionally, it is contemplated that in order to generate further contrast in the pile loop height difference between the guide bars, the first yarn feed 12 may be fed intentionally at a high knitting tension while the second yarn feed 16 is fed with a lower knitting tension. The higher knitting tension in conjunction with lower denier will generate shorter pile loops while the lower knitting tension will generate longer pile loops. It is further contemplated that variable pile heights may also be achieved by using sinker fingers or other loop forming elements with different effective heights at defined locations across the stitch bonding machine. That is, some locations may use higher sinker fingers producing higher loops than at others. As will be understood, such an arrangement may require a relatively high level of skill to set up and/or change but could be used if desired. Such variable height loop forming elements may be used either independently or in combination with variable denier loading as described previously to provide additional flexibility.

By way of example only, and not limitation, regardless of the formation techniques used, the first loop collection 14 may have an average pile height in the range of about 1.5 mm to about 3.5 mm and the second loop collection 18 may have an average pile height at least 25% greater than the first loop collection 14. More preferably, the second loop collection 18 may have an average pile height which is at least 50% to 150% greater than the first loop collection 14. Accordingly, if the first loop collection 14 has an average pile height of 2.5 mm, the second loop collection will preferably have an average pile height of at least 3.125 mm to 6.25 mm. In some constructions the second loop collection 18 may have an average pile height which is at least 200% greater (or more) than the first loop collection 14.

Of course, variations and modifications of the foregoing are within the scope of the present disclosure. Thus, it is to be understood that the disclosure disclosed and defined herein extends to all alternative combinations of two or more of the individual features mentioned or evident from the text and/or drawings. All of these different combinations constitute various alternative aspects of the disclosure. The embodiment described herein explain the best modes for practicing the disclosure and will enable others skilled in the art to utilize the disclosure. The claims are to be construed to include alternative embodiments and equivalents to the extent permitted by the prior art.

The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure, and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Various features of the disclosure are set forth in the following claims.

What is claimed is:

1. A disposable cleaning pad of stitch-bonded construction adapted to be affixed to a mop head for manipulation across a surface to be cleaned, the cleaning pad comprising: a stitching substrate comprising fleece in layered relation with at least one support layer; at least a first yarn feed and a second yarn feed disposed in stitched relation through a stitched portion of the stitching substrate, the first yarn feed forming a first loop collection within the stitched portion of the stitching substrate, the second yarn feed forming a second loop collection within the stitched portion of the stitching substrate, the second loop collection covering a smaller area than the first loop collection and defining a predefined pattern within the stitched portion of the stitching substrate, wherein the second loop collection has an average pile height greater than the first loop collection.

2. The disposable cleaning pad as recited in claim 1, wherein the stitching substrate comprises at least one layer of fiber fleece having a mass per unit area of 100 to 400 grams per square meter.

3. The disposable cleaning pad as recited in claim 1, wherein the stitching substrate comprises at least one layer of fiber fleece disposed in sandwiched relation between support layer substrates.

4. The disposable cleaning pad as recited in claim 1, wherein the first yarn feed is stitched in a zigzag atlas stitch.

5. The disposable cleaning pad as recited in claim 1, wherein the first yarn feed provides a cover factor of not greater than 85% across the underlying stitching substrate.

6. The disposable cleaning pad as recited in claim 1, wherein the first yarn feed provides a cover factor of 30% to 80% across the underlying stitching substrate.

7. The disposable cleaning pad as recited in claim 1, wherein the first loop collection has an average pile height in the range of about 1.5 mm to about 3.5 mm.

8. The disposable cleaning pad as recited in claim 1, wherein the second loop collection has an average pile height at least 25% greater than the first loop collection.

9. The disposable cleaning pad as recited in claim 1, wherein the second loop collection has an average pile height 25% to 150% greater than the first loop collection.

10. The disposable cleaning pad as recited in claim 1, wherein loops forming the second loop collection have an average yarn density not less than two times the average yarn density of loops forming the first loop collection.

11. The disposable cleaning pad as recited in claim 1, wherein loops forming the second loop collection have an average yarn density in the range of 2 to 5 times the average yarn density of loops forming the first loop collection.

12. A disposable cleaning pad of stitch-bonded construction adapted to be affixed to a mop head for manipulation across a surface to be cleaned, the cleaning pad comprising: a stitching substrate comprising polyester fleece disposed in sandwiched relation between substrate support layers, at least a first yarn feed and a second yarn feed disposed in stitched relation through a stitched portion of the stitching substrate, wherein the first yarn feed is stitched in a zigzag atlas stitch and provides a cover factor of 45% to 85% across the underlying stitching substrate, the first yarn feed forming a first loop collection within the stitched portion of the stitching substrate, the second yarn feed forming a second loop collection within the stitched portion of the stitching substrate, the second loop collection covering a smaller area than the first loop collection and defining a predefined pattern within the stitched portion of the stitching substrate, wherein the second loop collection has an average pile height greater than the first loop collection.

13. The disposable cleaning pad as recited in claim 12, wherein the stitching substrate comprises at least one layer of polyester fleece having a mass per unit area of 100 to 400 grams per square meter.

14. The disposable cleaning pad as recited in claim 12, wherein the first loop collection has an average pile height in the range of about 1.5 mm to about 3.5 mm.

15. The disposable cleaning pad as recited in claim 12, wherein the second loop collection has an average pile height at least 50% greater than the first loop collection.

16. The disposable cleaning pad as recited in claim 12, wherein the second loop collection has an average pile height 25% to 150% greater than the first loop collection.

17. The disposable cleaning pad as recited in claim 12, wherein loops forming the second loop collection have an average yarn density not less than two times the average yarn density of loops forming the first loop collection.

18. The disposable cleaning pad as recited in claim 12, wherein loops forming the second loop collection have an average yarn density in the range of 2 to 5 times the average yarn density of loops forming the first loop collection.

19. A disposable cleaning pad of stitch-bonded construction adapted to be affixed to a mop head for manipulation across a surface to be cleaned, the cleaning pad comprising: a sorbent stitching substrate comprising at least one layer of fiber fleece having a mass per unit area of 100 to 400 grams per square meter disposed in sandwiched relation between substrate support layers; at least a first yarn feed and a second yarn feed disposed in stitched relation through a stitched portion of the stitching substrate, the first yarn feed forming a first loop collection within the stitched portion of the stitching substrate, the second yarn feed forming a second loop collection within the stitched portion of the stitching substrate, the second loop collection covering a smaller area than the first loop collection and defining a predefined pattern within the stitched portion of the stitching substrate, wherein the first yarn feed is stitched in a zigzag atlas stitch and provides a cover factor of 30% to 85% across the underlying stitching substrate, the first loop collection having an average pile height in the range of 1.5 mm to 3.5 mm and the second loop collection having an average pile height at least 50% greater than the first loop collection and wherein the loops forming the second loop collection have an average yarn density not less than two times the average yarn density of the loops forming the first loop collection.
